(19) United States
(12) Patent Application Publication
(10) Pub. No.: US 2025/0208676 A1
(43) Pub. Date: Jun. 26, 2025

(54) VOLTAGE MARGIN OPTIMIZATION BASED ON WORKLOAD SENSITIVITY

(71) Applicant: Advanced Micro Devices, Inc., Santa Clara, CA (US)

(72) Inventors: Ashish Jain, Austin, TX (US); Sriram Sundaram, Austin, TX (US); Vydhyanathan Kalyanasundharam, Sunnyvale, CA (US)

(21) Appl. No.: 18/395,483

(22) Filed: Dec. 23, 2023

(51) Int. Cl. G06F 1/26

(52) U.S. Cl. CPC G06F 1/26

(57) ABSTRACT

An apparatus and method for efficiently managing, based on workload types, current transients that cause voltage transients on a power rail of an integrated circuit. In various implementations, a computing system includes a memory subsystem, multiple clients for processing tasks, and a communication fabric that transfers data between the memory subsystem and the multiple clients. If circuitry of the communication fabric (or “fabric”) determines the type of workload being processed by the multiple clients is memory latency sensitive and not peak memory bandwidth sensitive, then the circuitry assigns a high-performance clock frequency to the communication fabric and reduces an issue rate of memory requests to the memory subsystem. The reduced issue rate reduces the current transients, which reduces the amount of voltage droop margin to use for the workload. Accordingly, the communication fabric consumes less power. In response, power credits are redistributed from the communication fabric to the multiple clients.

### BACKGROUND

### Description of the Relevant Art

Current transients on a power rail of an integrated circuit include a time rate of current flow being drawn from or returned to the power rail. Large current transients on the power rail cause large voltage transients on the power rail. This voltage transient, ΔV, is proportional to the expression L di/dt. Here, the term “L” is the parasitic inductance of the power delivery network that includes the power rail corresponding to the supply pin. The term “di/dt” is the time rate of change of the current consumption. Large voltage transients of modern integrated circuits have become an increasing design issue with each generation of semiconductor chips. These appreciable voltage transients on the power rail caused by the current transients are not only an issue for portable computers and mobile communication devices, but also for desktops and servers.

Adjusting the operational clock frequency can reduce the voltage transients on the power rail caused by the current transients. However, reducing the operational clock frequency also reduces performance. When the operating clock frequency remains relatively high, selection of a power supply voltage can be based on a voltage margin derived from a voltage-frequency curve generated to account for voltage transients. However, each processing circuit of the integrated circuit uses the adjusted power supply voltage. When the processing circuits process tasks that do not produce voltage transients despite the high operating clock frequency, these processing circuits still experience the voltage margin penalty.

In view of the above, methods and systems for efficiently managing, based on workload types, current transients that cause voltage transients on a power rail of an integrated circuit are desired.

### BRIEF DESCRIPTION OF THE DRAWINGS

FIG. 1 is a generalized block diagram of a computing system that efficiently manages, based on workload types, current transients that cause voltage transients on a power rail of an integrated circuit.

FIG. 2 is a generalized block diagram of an apparatus that efficiently manages, based on workload types, current transients that cause voltage transients on a power rail of an integrated circuit.

FIG. 3 is a generalized block diagram of an apparatus that efficiently manages, based on workload types, current transients that cause voltage transients on a power rail of an integrated circuit.

FIG. 4 is a generalized block diagram of a method for efficiently managing, based on workload types, current transients that cause voltage transients on a power rail of an integrated circuit.

FIG. 5 is a generalized block diagram of a method for efficiently managing, based on workload types, current transients that cause voltage transients on a power rail of an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods that efficiently manage, based on workload types, current transients that cause voltage transients on a power rail of an integrated circuit are contemplated. In various implementations, a computing system includes a memory subsystem and multiple clients capable of processing tasks. Examples of the clients are a central processing unit (CPU), a graphics processing unit (GPU), digital signal processing circuits (DSPs), field programmable gate arrays (FPGAs), application specific integrated circuits (ASICs), and a variety of other types of processing circuits and interface circuits. The computing system also includes a communication fabric that transfers data between the memory subsystem and the multiple clients.

The communication fabric (or “fabric”) includes circuitry for transferring requests, responses, and messages between the clients, between the clients and peripheral devices, and between the clients and the memory subsystem. In addition to supporting data transmission, the fabric also includes circuitry for supporting communication and network protocols, address formats, and synchronous/asynchronous clock domain usage for routing data. The fabric also includes include queues for storing requests and responses, and selection circuitry for arbitrating between received requests before sending requests to the next stage of routing.

Additionally, the fabric includes a system management circuit that includes circuitry that determines one or more types of workloads of the tasks being processed by the multiple clients. In an implementation, the system management circuit determines a type of workload based on the type of application providing the tasks. For example, a compute-intensive application provides a memory latency sensitive workload. A video graphics rendering application provides a memory bandwidth sensitive workload. In another implementation, the system management circuit determines a type of workload based on a type of a source generating memory requests where the source is one of the multiple clients. In yet another implementation, the system management circuit monitors, by accessing performance counters, a rate of memory requests generated by the multiple clients while processing tasks, and the system management circuit uses the rate to determine the type of the currently executing workload.

If the system management circuit determines the type of workload is memory latency sensitive and not peak memory bandwidth sensitive, then the system management circuit assigns a high-performance operating clock frequency to the communication fabric. The system management circuit also reduces the issue rate of memory requests to the memory subsystem, which reduces the memory bandwidth to below the peak memory bandwidth. Additionally, the system management circuit assigns a power supply voltage less than a high-performance power supply voltage for the communication fabric by selecting a smaller voltage guardband that is less than the voltage guardband used for worst-case voltage droop at the high-performance clock frequency. The voltage guardbands are derived from a voltage-frequency curve of the integrated circuit. As used herein, the term “voltage margin” is also referred to as “voltage guardband.” The voltage guardband is added to a power supply voltage in anticipation of a later voltage droop event occurring that reduces the power supply voltage due to undershoot. As described earlier, the voltage droop, or the voltage transient ΔV, is proportional to the expression L di/dt.

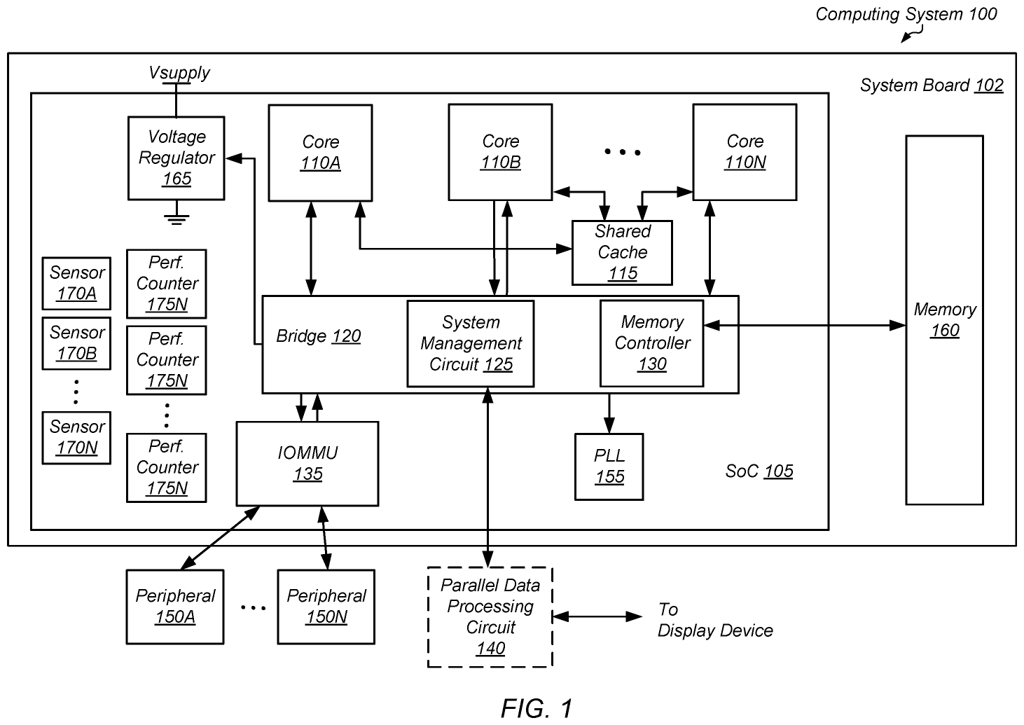

The communication fabric processes memory requests and other tasks using the reduced memory bandwidth (due to the reduced issue rate), the reduced power supply voltage, and the high-performance operating clock frequency. Therefore, the communication fabric processes tasks that do not produce voltage transients despite using the high-performance operating clock frequency. These steps performed by the system management circuit maintain performance while also reducing a sudden, large change in the time rate of change of the current flow, di/dt, either returned to or drawn from a power rail of the communication fabric. When the current transients on the power rail are reduced, the voltage transients on the power rail are also reduced. Therefore, the circuitry of the fabric does not utilize the full voltage margin (voltage guardband) assigned to the worst-case voltage droop at the high-performance clock frequency. Accordingly, the communication fabric consumes less power while processing tasks. In response, the system management circuit redistributes power credits from the communication fabric to the multiple clients despite the communication fabric using the high-performance operating clock frequency. Further details of these techniques to reduce the voltage transients on a power rail caused by current transients of an integrated circuit are provided in the following description of FIGS. 1-5.

Referring now to FIG. 1, a generalized block diagram is shown of one implementation of a computing system 100 that efficiently manages, based on workload types, current transients that cause voltage transients on a power rail of an integrated circuit. In this implementation, computing system 100 includes a system on chip (SoC) 105 connected to memory 160. However, implementations in which one or more of the illustrated components of the SoC 105 are not integrated onto a single chip are possible and are contemplated. In some implementations, SoC 105 includes multiple processor cores 110A-110N and a parallel data processing circuit 140. Examples of the parallel data processing circuit 140 are a graphics processing unit (GPU), a digital signal processing circuits (DSP), a field programmable gate arrays (FPGA), an application specific integrated circuit (ASIC), and a variety of other types of parallel data processing circuits.

In the illustrated implementation, the SoC 105, Memory 160, and other components (not shown) are part of a system board 102, and one or more of the peripherals 150A-150N and parallel data processing circuit 140 are discrete entities (e.g., daughter boards, etc.) that are connected to the system board 102. In other implementations, parallel data processing circuit 140 and/or one or more of the peripherals 150 are permanently mounted on system board 102 or otherwise integrated into SoC 105. In various implementations, computing system 100 can be a computer, laptop, mobile device, server, web server, cloud computing server, storage system, or any of various other types of computing systems or devices. It is noted that the number of components of computing system 100 and/or SoC 105 can vary from implementation to implementation. There can be more or fewer of each component/subcomponent than the number shown in FIG. 1. It is also noted that computing system 100 and/or SoC 105 can include other components not shown in FIG. 1. Additionally, in other implementations, computing system 100 and SoC 105 can be structured in other ways than shown in FIG. 1.

In some implementations, SoC 105 includes the parallel data processing circuit 140 connected to a display device (not shown) of the computing system 100. In some implementations, the parallel data processing circuit 140 is an integrated circuit that is separate and distinct from SoC 105. The parallel data processing circuit 140 performs various video processing functions and provides the processed information to the display device for output as visual information. The parallel data processing circuit 140 can also perform other types of highly parallel data tasks. The parallel data processing circuit 140 includes multiple compute circuits, each with multiple parallel lanes of execution. Each of the multiple compute circuits is capable of generating memory requests.

It is noted that processor cores 110A-N can also be referred to as processing circuits or processors. Processor cores 110A-N and the parallel data processing circuit 140 execute instructions of one or more instruction set architectures (ISAs), which can include operating system instructions and user application instructions. These instructions include memory access instructions which can be translated and/or decoded into memory access requests or memory access operations targeting memory 160. In another implementation, SoC 105 includes a single processor core. In multi-core implementations, processor cores 110 are identical to each other (i.e., symmetrical multi-core), or one or more cores can be different from others (i.e., asymmetric multi-core). Each of the processor cores 110A-110N includes one or more execution blocks, cache memories, schedulers, branch prediction circuits, and so forth. Furthermore, each of processor cores 110A-110N generates memory requests that target data storage locations in the memory 160. In some implementations, the memory 160 is main memory for the computing system 100.

The memory requests include read requests, write requests, and snoop requests. Similarly, the parallel data processing circuit 140, the peripherals 150A-150N, and the IOMMU 135 also generate memory requests. These memory requests are initially received from a respective processor core 110 by bridge 120. As used herein, a “client” is a processing circuit that processes, or executes, tasks, such as applications. The processor cores 110A-110N, the parallel data processing circuit 140, the peripherals 150A-150N, and the IOMMU 135 are examples of clients. Clients generate memory requests while processing tasks.

Each of the processor cores 110A-110N includes a queue or buffer that holds in-flight instructions that have not yet completed execution. This queue can be referred to herein as an “instruction queue.” Some of the instructions in one of the processor cores 110A-110N can still be waiting for their operands to become available, while other instructions can be waiting for an available arithmetic logic unit (ALU). The instructions which are waiting on an available ALU can be referred to as pending ready instructions. In one implementation, each of the processor cores 110A-110N tracks the number of pending ready instructions.

Input/output memory management circuit (IOMMU) 135 is connected to the bridge 120. In one implementation, the bridge 120 functions as a northbridge device and IOMMU 135 functions as a southbridge device in the computing system 100. In other implementations, bridge 120 is a switch, bridge, any combination of these components, or another component. In yet another implementation, bridge 120 is a communication fabric (or fabric). To efficiently route data, in various implementations, the bridge 120, when used as a communication fabric, utilizes a routing network (not shown) that includes network switches. In some implementations, the network switches are network on chip (NoC) switches. In an implementation, the routing network uses multiple network switches in a point-to-point (P2P) ring topology. In other implementations, the routing network uses network switches with programmable routing tables in a mesh topology. In yet other implementations, the routing network of bridge 120 uses network switches in a combination of topologies. In some implementations, the routing network includes one or more buses to reduce the number of wires in the computing system 100.

When network messages being transferred through the bridge 120 include requests for obtaining targeted data, one or more of interfaces and network switches in the bridge 120 translate target addresses of requested data. In various implementations, the bridge 120, when used as a communication fabric, includes status and control registers and other storage elements for storing requests, responses, and control parameters. In some implementations, bridge 120 includes control circuitry for supporting communication, data transmission, and network protocols for routing data over one or more buses. In some implementations, bridge 120 includes control circuitry for supporting address formats, interface signals and synchronous/asynchronous clock domain usage.

A number of different types of peripheral buses (e.g., peripheral component interconnect (PCI) bus, PCI-Extended (PCI-X), PCIE (PCI Express) bus, gigabit Ethernet (GBE) bus, universal serial bus (USB)) can be connected to IOMMU 135. Various types of peripheral devices 150A-150N can be connected to some or all the peripheral buses. Such peripheral devices 150A-150N include (but are not limited to) keyboards, mice, printers, scanners, joysticks or other types of game controllers, media recording devices, external storage devices, network interface cards, and so forth. At least some of the peripheral devices 150A-150N that are connected to IOMMU 135 via a corresponding peripheral bus can generate memory access requests using direct memory access (DMA). These requests (which can include read and write requests) are conveyed to bridge 120 via IOMMU 135.

In an implementation, memory controller 130 is integrated into bridge 120. In other implementations, memory controller 130 is separate from bridge 120. Memory controller 130 receives memory requests conveyed from bridge 120. Request data targeted by memory requests are retrieved from memory 160 by the memory controller 130 and sent to the requesting client via bridge 120. Responsive to a write request, memory controller 130 receives both the request and the data to be written from the requesting client through bridge 120. If multiple memory access requests are pending at a given time, memory controller 130 arbitrates between these requests. For example, memory controller 130 can give priority to critical requests while delaying non-critical requests when the power budget allocated to memory controller 130 restricts the total number of requests that can be performed to memory 160.

In some implementations, memory 160 includes a plurality of memory modules. Each of the memory modules includes one or more memory devices (e.g., memory chips) mounted thereon. In some implementations, memory 160 includes one or more memory devices mounted on a motherboard or other carrier upon which SoC 105 is also mounted. In some implementations, at least a portion of memory 160 is implemented on the die of SoC 105 itself. In one implementation, memory 160 is used to implement a random-access memory (RAM) for use with SoC 105 during operation. The RAM implemented can be static RAM (SRAM) or dynamic RAM (DRAM). The type of DRAM that is used to implement memory 160 includes (but are not limited to) double data rate (DDR) DRAM, DDR2 DRAM, DDR3 DRAM, and so forth.

Although not explicitly shown in FIG. 1, SoC 105 can also include one or more cache memories that are internal to the processor cores 110A-110N. For example, each of the processor cores 110A-110N can include a level-one (L1) data cache and an L1 instruction cache. In some implementations, SoC 105 includes a shared cache 115 that is shared by the processor cores 110A-110N. In some implementations, shared cache 115 is a level-two (L2) cache. In some implementations, each of processor cores 110A-110N has an L2 cache implemented therein, and thus shared cache 115 is a level three (L3) cache. Cache 115 can be part of a cache subsystem including a cache controller.

In one implementation, system management circuit 125 is integrated into bridge 120. In other implementations, system management circuit 125 can be separate from bridge 120 and/or system management circuit 125 can be implemented as multiple, separate components in multiple locations of SoC 105. System management circuit 125 includes hardware, such as circuitry, that manages the power states of the various clients of SoC 105. System management circuit 125 can also be referred to as a power management circuit. In one implementation, system management circuit 125 uses dynamic voltage and frequency scaling (DVFS) to change the operating parameters of a client. Examples of the operating parameters are an operating clock frequency and an operating power supply voltage level. System management circuit 125 uses DVFS to limit the power consumption of a client to a chosen power allocation.

SoC 105 includes multiple temperature sensors 170A-170N, which are representative of any number of temperature sensors. It should be understood that while sensors 170A-170N are shown on the left-side of the block diagram of SoC 105, sensors 170A-170N can be spread throughout the SoC 105 and/or can be located next to the major components of SoC 105 in the actual implementation of SoC 105. In this implementation, each sensor 170A-N tracks the temperature of a corresponding component. In another implementation, there is a sensor of the sensors 170A-170N for different on-die area regions of SoC 105. In other implementations, other schemes for positioning the sensors 170A-N within SoC 105 are possible and are contemplated.

SoC 105 also includes multiple performance counters 175A-175N, which are representative of any number and type of performance counters. It should be understood that while performance counters 175A-175N are shown on the left-side of the block diagram of SoC 105, performance counters 175A-N can be spread throughout the SoC 105 and/or can be located within the major components of SoC 105 in the actual implementation of SoC 105. Performance counters 175A-N can track a variety of different performance metrics, including the instruction execution rate of cores 110A-110N and the parallel data processing circuit 140, consumed memory bandwidth, row buffer hit rate, cache hit rates of various caches (e.g., instruction cache, data cache), and/or other metrics.

In one implementation, SoC 105 includes a phase-locked loop (PLL) circuit 155 that receives a system clock signal. PLL circuit 155 includes a number of PLLs that generate and distribute corresponding clock signals to components of SoC 105. PLL circuit 155 is able to individually control and alter the operating clock frequency of each of the clock signals provided to respective components of SoC 105. Ones of processor cores 110 independently of one another. The operating clock frequency of the clock signal received by any client of SoC 105 can be increased or decreased in accordance with power-performance states (P-states) assigned by system management circuit 125.

As used herein, an “operating point” is defined as an operating clock frequency and can also include an operating power supply voltage (e.g., supply voltage provided to a client). Increasing an operating point for a given client can be defined as increasing the operating clock frequency of a clock signal provided to that client and can also include increasing its operating power supply voltage. Similarly, decreasing an operating point for the client can be defined as decreasing the operating clock frequency, and can also include decreasing the operating power supply voltage. Limiting an operating point can be defined as limiting the operating clock frequency and/or the operating power supply voltage to specified maximum values for a particular set of conditions (but not necessarily maximum limits for all conditions). Thus, when an operating point is limited for a particular client, the client can operate at a clock frequency and operating voltage up to the specified values for a current set of conditions but can also operate at clock frequency and operating voltage values that are less than the specified values.

In the case of changing the respective operating points of one or more processor cores 110A-110N includes changing of one or more respective clock frequencies, system management circuit 125 changes the state of digital signals provided to PLL circuit 155. Responsive to the change in these signals, PLL circuit 155 changes the clock frequency of the affected processing core(s) 110A-110N. Additionally, system management circuit 125 can also cause PLL circuit 155 to inhibit a respective clock signal from being provided to a corresponding one of the processor cores 110A-110N.

In the illustrated implementation, SoC 105 also includes voltage regulator 165. In other implementations, voltage regulator 165 can be implemented separately from SoC 105. Voltage regulator 165 provides a supply voltage to each core of processor cores 110A-110N and to other components of SoC 105. In some implementations, voltage regulator 165 provides a supply voltage that is variable according to a particular operating point. In some implementations, each of processor cores 110A-110N shares a voltage plane. Thus, each of the processing cores 110A-110N in such an implementation operates at the same voltage as the other ones of the processor cores 110A-110N.

In another implementation, voltage planes are not shared, and thus the supply voltage received by each of the processor cores 110A-110N is set and adjusted independently of the respective supply voltages received by other ones of the processor cores 110A-110N. Thus, operating point adjustments that include adjustments of a supply voltage can be selectively applied to each of the processor cores 110A-110N independently of the others in implementations having non-shared voltage planes. In the case where changing the operating point includes changing an operating voltage for one or more of the processor cores 110A-110N, system management circuit 125 changes the state of digital signals provided to voltage regulator 165. Responsive to the change in the signals, voltage regulator 165 adjusts the supply voltage provided to the affected ones of processor cores 110A-110N and other components including components within the bridge 120. In instances when power is to be removed from (i.e., gated) one or more of the processor cores 110A-110N, system management circuit 125 sets the state of corresponding ones of the signals to cause voltage regulator 165 to provide no power to the affected ones of the processor cores 110A-110N.

The system management circuit 125 also includes circuitry that determines one or more types of workloads of the tasks being processed by the multiple clients such as the processor cores 110A-110N, the parallel data processing circuit 140, the peripherals 150A-150N, and the IOMMU 135. In an implementation, system management circuit 125 determines a type of workload based on the type of application providing the tasks. For example, a compute-intensive application provides a memory latency sensitive workload. A video graphics rendering application provides a memory bandwidth sensitive workload. In another implementation, system management circuit 125 determines a type of workload based on the type of a source generating memory requests where the source is one of the multiple clients. In yet another implementation, the system management circuit 125 monitors, by accessing the performance counters 175A-175N, a rate of memory requests generated by the multiple clients while processing tasks, and the system management circuit 125 uses the rate to determine the type of the currently executing workload.

If the system management circuit 125 generates an indication specifying that the type of workload is a memory latency sensitive workload and not a peak memory bandwidth sensitive workload, then the system management circuit 125 assigns a high-performance operating clock frequency to the bridge 120. In some implementations, system management circuit 125 also instructs the memory controller 130 to reduce an issue rate of memory requests to a memory subsystem that includes at least the memory 160. In other implementations, in response to the indication specifying the workload type, other control circuitry of bridge 120 or memory controller 130 generates an indication specifying the reduction of the issue rate of memory requests. This reduction of the issue rate reduces the memory bandwidth to below the peak memory bandwidth. In an implementation, the memory controller 130 supports a peak memory bandwidth of 1 terabyte (TB) of data per second (1 TB/s) with the memory 160. After the system management circuit 125 instructs the memory controller 130 to reduce the issue rate of memory requests, the memory controller issues memory requests every other clock cycle to reduce the memory bandwidth from 1 TB/s to 500 gigabytes per second (500 GB/s). Other reductions are possible and contemplated.

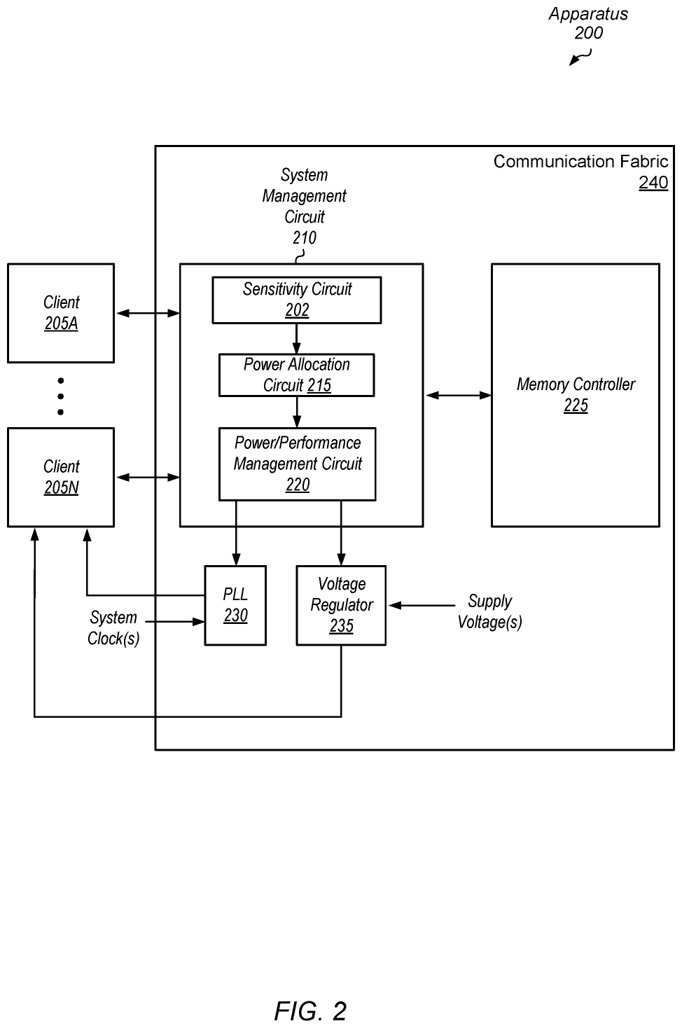

Additionally, in various implementations, the system management circuit 125 reduces the power supply voltage of the operating parameters for the bridge 120 by selecting a smaller voltage guardband that is less than the voltage guardband used for worst-case voltage droop at the high-performance clock frequency. The bridge 120 processes memory requests and other tasks using the reduced memory bandwidth (due to the reduced issue rate), the reduced power supply voltage (due to the reduced voltage guardband), and the high-performance operating clock frequency. Therefore, bridge 120 processes tasks that do not produce voltage transients despite using the high-performance operating clock frequency. These steps performed by the system management circuit 125 maintains performance of the latency sensitive workload by not limiting the operating clock frequency of bridge 120, while also reducing a sudden, large change in the time rate of change of the current flow, di/dt, either returned to or drawn from a power rail of the bridge 120. When the current transients on the power rail are reduced, the voltage transients on the power rail are also reduced. Accordingly, a smaller power supply voltage guardband can be used that is less than the voltage guardband used for worst-case voltage droop. Accordingly, bridge 120 consumes less power while processing tasks. In response, system management circuit 125 redistributes power credits from the bridge 120 to the multiple clients (e.g., the processor cores 110A-110N, the parallel data processing circuit 140, the peripherals 150A-150N, and the IOMMU 135). The system management circuit 125 redistributes these power credits despite the bridge 120 using the high-performance clock frequency. The usage of power credits is further described shortly regarding the apparatus 200 (of FIG. 2).

Turning now to FIG. 2, a generalized block diagram is shown of an apparatus 200 that efficiently manages, based on workload types, current transients that cause voltage transients on a power rail of an integrated circuit. Apparatus 200 includes the communication fabric 240 (or fabric 240) and the clients 205A-205N. In some implementations, fabric 240 has the functionality of the bridge 120 (of FIG. 1). Each of the clients 205A-205N is a processing circuit that processes, or executes, tasks, such as applications, and generate memory requests while processing tasks. Examples of the clients 205A-205N are a central processing unit (CPU), a graphics processing unit (GPU), digital signal processing circuits (DSPs), field programmable gate arrays (FPGAs), application specific integrated circuits (ASICs), and a variety of other types of processing circuits and interface circuits.

The system management circuit 210 is connected to at least the clients 205A-205N, the memory controller 225, the phase-locked loop (PLL) circuit 230, and the voltage regulator 235. The system management circuit 210 can also be connected to one or more other components not shown in apparatus 200. Memory controller 225 controls access to a memory (not shown) of a host computing system. For example, memory controller 225 issues read, write, erase, refresh, and various other commands to the memory. In various implementations, the memory controller 225 has the same functionality as the memory controller 130 (of FIG. 1). Similarly, the PLL circuit 230 and the voltage regulator 235 have the same functionalities of the PLL circuit 155 and the voltage regulator 165 (of FIG. 1), respectively.

System management circuit 210 includes the sensitivity circuit 202, the power allocation circuit 215, and the power management circuit 220. The sensitivity circuit 202 determines the types of workloads being processed by the clients 205A-205N. In an implementation, the sensitivity circuit 202 determines a type of workload based on a type of application providing the tasks to the clients 205A-205N. For example, a compute-intensive application provides a memory latency sensitive workload. A video graphics rendering application provides a memory bandwidth sensitive workload to one or more of the clients 205A-205N. In another implementation, the sensitivity circuit 202 determines a type of workload based on a type of a source generating memory requests where the source is one of the clients 205A-205N. In yet another implementation, the sensitivity circuit 202 monitors, by accessing performance counters, a rate of memory requests generated by the clients 205A-205N while processing tasks, and the sensitivity circuit 202 uses the rate to determine the type of the currently executing workload.

Power allocation circuit 215 allocates a power budget, such as a number of power credits, to each of the clients 205A-205N, to a memory subsystem including memory controller 225, to the fabric 240, and/or to one or more other components. The total amount of power credits available to power allocation circuit 215 to be dispersed to the components can be capped for the host system. To manage power consumption, the system management circuit 125 transfers power credits between components. In such a case, a first component can be operating in a mode corresponding to given normal or high-power consumption. In contrast, a second component can have an activity level below a given threshold. Transferring power away from the relatively inactive second component to the active first component allows the first component to further increase its activity level or maintain its current activity level for a longer duration of time. In such a case, on-chip performance can increase without creating further cooling efforts from a cooling system.

The total amount of power credits is typically set by a thermal design power (TDP). The TDP is the amount of power that a cooling system can dissipate. Therefore, to prevent failure, a computing system typically operates within the TDP value. Power allocation circuit 215 determines a number of power credits to donate to a selected component based on a corresponding activity level. In response to receiving additional (donated) power credits, the selected component transitions to a different P-state.

The power allocation circuit 215 receives various inputs from the clients 205A-205N including an indication specifying an activity level, the instruction execution rates, the number of pending ready-to-execute instructions, the instruction and data cache hit rates, the consumed memory bandwidth, and/or one or more other input signals. The power allocation circuit 215 utilizes these inputs to determine whether the clients 205A-205N have tasks to execute, and then the power allocation circuit 215 can adjust the power budget allocated to the clients 205A-205N according to these determinations.

The power allocation circuit 215 can also receive inputs from memory controller 225, with these inputs including the consumed memory bandwidth, number of total requests in the pending request queue, number of critical requests in the pending request queue, number of non-critical requests in the pending request queue, and/or one or more other input signals. The power allocation circuit 215 utilizes the status of these inputs to determine the power budget that is allocated to the memory subsystem. The power management circuit 220 sends control signals to PLL 230 to control the clock frequencies supplied to the clients 205A-205N and to other components. The power management circuit 220 also sends control signals to voltage regulator 235 to control the voltages supplied to the clients 205A-205N and to other components.

As described earlier, if the system management circuit 210 determines the type of a workload being processed by one or more of the clients 205A-205N is a memory latency sensitive workload and no workload is a peak memory bandwidth sensitive workload, then the system management circuit 210 assigns a high-performance operating clock frequency to the communication fabric 240. The system management circuit 210 also reduces an issue rate of memory requests for the memory controller 225, which reduces the memory bandwidth to below the peak memory bandwidth. Additionally, the system management circuit 210 reduces the power supply voltage of the operating parameters for the communication fabric 240 by selecting a smaller voltage guardband that is less than the voltage guardband used for worst-case voltage droop. The communication fabric 240 processes memory requests and other tasks using the reduced memory bandwidth (due to the reduced issue rate), the reduced power supply voltage, and the high-performance operating clock frequency. Therefore, communication fabric 240 processes tasks that do not produce voltage transients despite using the high-performance operating clock frequency. Further, the system management circuit 210 redistributes power credits from the communication fabric 240 to one or more of the clients 205A-205N despite the communication fabric 240 using the high-performance operating clock frequency.

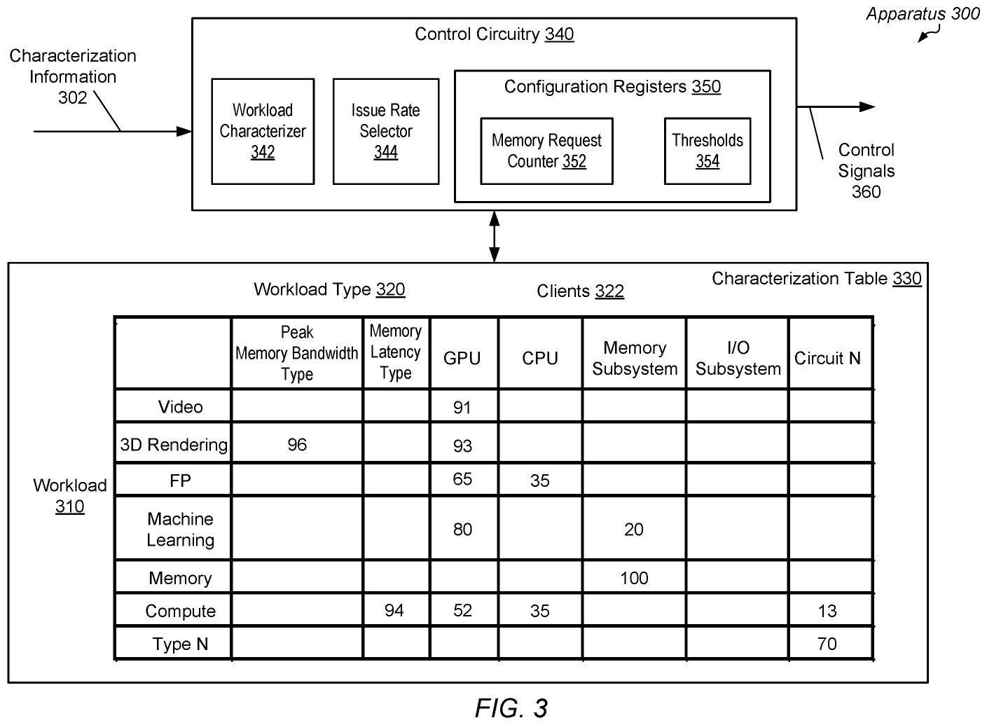

Referring to FIG. 3, a generalized block diagram is shown of an apparatus 300 that efficiently manages, based on workload types, current transients that cause voltage transients on a power rail of an integrated circuit. In the illustrated implementation, the apparatus 300 includes control circuitry 340 and the characterization table 330 (or table 330). The control circuitry 340 receives the characterization information 302 and information from the table 330 and generates the control signals 360. The control circuitry 340 includes the workload characterizer 342, the issue rate selector 344, and the configuration registers 350. The control signals 360 are used to select operating parameters of a communication fabric, which can include a last-level cache shared by multiple clients in an implementation. The control signals 360 are also used to select an issue rate of memory requests to the memory controller for issuing memory requests to the memory subsystem that includes system memory and main memory.

Table 330 is implemented with one of flip-flop circuits, one of a variety of types of a random-access memory (RAM), a content addressable memory (CAM), or other. Although particular information is shown as being stored in table 330, and in a particular contiguous order, in other implementations, a different order is used, and a different number and type of information is stored. Table 330 includes information that characterizes a relationship between workload types 320 and different clients 322 and different workloads 310. Although the table 330 shows a particular data storage arrangement to describe the relationships between workload types 320 and clients 322 and workloads 310, it is possible and contemplated that the table 330 uses a variety of other data storage arrangements.

As shown in the illustrated implementation, the workload types 320 include a peak memory bandwidth type and a memory latency type. The workloads 310 include video streaming, 3D rendering, floating point (FP), Neural Network (machine learning), memory (memory bandwidth sensitive), compute/computation (memory latency sensitive), I/O, and other Types. Any number and type of workload can be characterized. The clients 322 include GPU, CPU, Memory subsystem, I/O subsystem, as well as other circuit types. Similar to the workload types, any number and type of circuits can be characterized.

For purposes of discussion, sample values are shown in table 330 in a few entries for illustrative purposes. Other values are possible and are contemplated. Further, additional data can be maintained for each entry. Some values are shown as normalized values between 0 and 100. A sensitivity of 0 indicates no sensitivity between the corresponding one of the workloads 310 and the corresponding one of the workload types 320 and the clients 322. In contrast, a sensitivity of 100 indicates a strong sensitivity between the corresponding one of the workloads 310 and the corresponding one of the workload types 320 and the clients 322.

The control circuitry 340 receives the characterization information 302. The characterization information 302 includes one or more of an application identifier (ID), a process identifier, a source identifier of clients that generate memory requests, a hint or other identification from software (e.g., compiler, firmware, application) specifying a workload type, values stored in one or more performance counters, and so forth. Based on characterization information 302 and table 330, the workload characterizer 342 generates an indication specifying the workload type of the currently executing workload. Examples of the workload type are the workload types 320 such as a peak memory bandwidth type and a memory latency type. The workload characterizer 342 also updates the values stored in table 330 based on a result (indication) generated by the workload characterizer 342 and any feedback information from the computing system indicating whether the characterization was accurate.

In some implementations, workload characterizer 342 generates an indication specifying a workload is memory latency sensitive based on a rate of compute-intensive operations stored in performance counters and reported in characterization information 302. Workload characterizer 342 compares the received rate of compute-intensive operations to a threshold rate stored in a programmable configuration register of threshold registers 354. If the received rate of compute-intensive operations is greater than the threshold rate, then workload characterizer 342 generates the indication specifying the workload is memory latency sensitive. In an implementation, workload characterizer 342 generates an indication specifying a workload is not memory bandwidth sensitive based on a rate of memory requests generated by the multiple clients is less than a threshold. In some implementations, the rate of memory requests generated by the multiple clients is stored in performance counters and reported in characterization information 302.

In other implementations, workload characterizer 342 updates a count stored in memory request counter 352 of configuration registers 350 based on stored counts in characterization information 302. In some implementations, workload characterizer 342 also measures a number of clock cycles and equates this number to an amount of time based on the currently used operating clock frequency of the communication fabric. Therefore, workload characterizer 342 generates a rate of memory requests. In an implementation, workload characterizer 342 resets the count to a reset value after a threshold amount of time has elapsed. The threshold registers 354 stores the rate of memory requests threshold and the threshold amount of time in programmable configuration registers. In various implementations, when workload characterizer 342 generates an indication specifying that the currently executing workload is memory latency sensitive and not memory bandwidth sensitive, workload characterizer 342 notifies issue rate selector 344, which reduces the next issue rate to use by the memory controller.

During characterization, many applications and tasks are executed on the computing system while monitoring occurs regarding performance of individual circuits, overall performance of the system, current being drawn, frequencies of operation, changes in performance with respect to changes in power, and so on. Additionally, performance counters within the system are tracked and monitored in order to correlate values of the performance counters with types of applications and tasks. The values of these performance counters can be included in characterization information 302. In this manner, the given types of tasks and application are identifiable based on the values of the performance counters. For example, in such an implementation, data values are maintained within the performance counters that correlate workload types with various performance counter values. This approach gives a level of insight into current task processing. For example, while it can be known that a given task type has been scheduled for execution by a task scheduler of an operating system, that task type can include a variety of phases of execution. For example, one phase can be a compute-intensive phase, while another phase can be a memory bandwidth intensive phase. By having access to the performance counter values, the particular phase of execution can be identified and accounted for when allocating identifying workload types, adjusting the issue rate of memory requests, and assigning operating parameters to the communication fabric, the clients, and the memory subsystem.

The issue rate selector 344 determines the next issue rate to use by the memory controller for issuing memory requests to the memory subsystem. In some implementations, the memory controller issues memory requests to a last-level cache of the memory subsystem shared by the multiple clients. In an implementation, the memory controller has a peak memory bandwidth of 1 terabyte (TB) of data per second (1 TB/s) with this shared last-level cache of the memory subsystem. The issue rate selector 344 determines whether the next issue rate maintains the peak memory bandwidth or the next issue rate is less than the peak memory bandwidth. The issue rate selector 344 can select a positive fraction less than one. For example, the issue rate selector 344 can select a value indicated by the fraction ⅓, a normalized value between 0 and 100 of 33, a ratio of 33%, or another similar value. When the memory controller receives this value from the control signals 360, the memory controller begins to issue memory requests every one of three clock cycles to reduce the memory bandwidth from the peak bandwidth of 1 TB/s to 333 gigabytes per second (333 GB/s). Other reductions are possible and contemplated.

Voltage transients (positive or negative) of a power rail occur when the workload transitions from light to heavy, or vice-versa, in a relatively short amount of time. As described earlier, the voltage transients are caused by the relatively sudden current transients, or a rate of change of the amount of current drawn from or returned to the power rail. Suddenly returning a large amount of the power supply current to the power rail in a relatively short amount of time causes a condition referred to as “overshoot.” Due to the current transients that have not been mitigated, the overshoot condition includes the final voltage of the shared power rail being greater than the initial voltage of the shared power rail by more than a threshold voltage difference. Voltage transients are non-zero differences between the initial voltage and the final voltage of the shared power rail during a particular duration of time. As described earlier, the voltage transient, ΔV, is proportional to the expression L di/dt. The overshoot condition occurs when the workload transitions from heavy to light in a relatively short amount of time.

In contrast, suddenly drawing a large amount of the power supply current from the shared power rail in a relatively short amount of time causes a condition referred to as “undershoot.” Due to the current transients that have not been mitigated, the undershoot condition includes the final voltage of the shared power rail being less than the initial voltage of the shared power rail by more than a threshold voltage difference. The undershoot condition occurs when the workload transitions from light to heavy in a relatively short amount of time. The undershoot condition is also referred to as “voltage droop.” When the operating clock frequency remains relatively high, selection of a power supply voltage can be based on a voltage margin (or voltage guardband) derived from a voltage-frequency curve generated to account for at least circuit stability, circuit performance, and voltage droop. However, each processing circuit of the integrated circuit uses the adjusted power supply voltage. When the processing circuits process tasks that do not produce voltage transients despite the high operating clock frequency, these processing circuits still experience the voltage margin penalty. To avoid this penalty, similar to the system management circuit 125 (of FIG. 1) and the system management circuit 210 (of FIG. 2), the apparatus 300 determines the workload type and based on this workload type, selects the issue rate of memory requests for the memory controller, and selects the operating parameters of the communication fabric.

In various implementations, when the workload characterizer 342 determines the workload type is a memory latency sensitive workload and not a peak memory bandwidth sensitive workload, the control circuitry 340 generates the control signals 360 that indicate assigning a high-performance clock frequency to the communication fabric. The generated control signals 360 also indicate assigning, to the communication fabric, a power supply voltage based on a smaller voltage guardband that is less than the voltage guardband used for worst-case voltage droop at the high-performance clock frequency. The issue rate selector 344 generates signals of the control signals 360 that indicate a reduced memory request issue rate that provides a memory bandwidth less than a peak memory bandwidth. These steps performed by control circuitry 340 reduce the time rate of change of the current flow, di/dt, drawn from a power rail of the communication fabric. The reduction of di/dt reduces the amount of voltage droop margin (voltage droop guardband) to use when assigning the power supply voltage while utilizing the high-performance operating clock frequency to meet the requirements of latency sensitive workloads. In some implementations, control circuitry 340 also sends an indication, via the control signals 360, specifying redistribution of power credits among the communication fabric and the multiple clients. In other implementations, another circuit, such as a power management circuit or other system management circuitry, detects the lower power supply voltage, and in response, performs the redistribution of power credits among the communication fabric and the multiple clients.

In some implementations, one or more of the processing circuits, the compute circuits, and apparatuses illustrated in FIGS. 1-3 are implemented as chiplets. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet.

A second silicon wafer (or second wafer) is fabricated with multiple instantiated copies of integrated circuitry of a second chiplet, and this second wafer is diced using laser cutting techniques to separate the multiple copies of the second chiplet. The first chiplet provides functionality different from the functionality of the second chiplet. One or more copies of the first chiplet are placed in an integrated circuit, and one or more copies of the second chiplet is placed in the integrated circuit. The first chiplet and the second chiplet are interconnected to one another within a corresponding MCM. Such a process replaces a process that fabricates a third silicon wafer (or third wafer) with multiple copies of a single, monolithic semiconductor die that includes the functionality of the first chiplet and the second chiplet as integrated functional blocks within the single, monolithic semiconductor die.

Process yield of single, monolithic dies on a silicon wafer is lower than process yield of smaller chiplets on a separate silicon wafer. In addition, a semiconductor process can be adapted for the particular type of chiplet being fabricated. With single, monolithic dies, each die on the wafer is formed with the same fabrication process. However, it is possible that an interface functional block does not require process parameters of a semiconductor manufacturer's expensive process that provides the fastest devices and smallest geometric dimensions. With separate chiplets, designers can add or remove chiplets for particular integrated circuits to readily create products for a variety of performance categories. In contrast, an entire new silicon wafer must be fabricated for a different product when single, monolithic dies are used. It is possible and contemplated that one or more of the processing circuits, the compute circuits, and apparatuses illustrated in FIGS. 1-3 are implemented as chiplets.

In some implementations, the hardware of the processing circuits and the apparatuses illustrated in FIGS. 1-3 is provided in a two-dimensional (2D) integrated circuit (IC) with the dies placed in a 2D package. In other implementations, the hardware is provided in a three-dimensional (3D) stacked integrated circuit (IC). A 3D integrated circuit includes a package substrate with multiple semiconductor dies (or dies) integrated vertically on top of it. Utilizing three-dimensional integrated circuits (3D ICs) further reduces latencies of input/output signals between functional blocks on separate semiconductor dies. It is noted that although the terms “left,” “right,” “horizontal,” “vertical,” “row,” “column,” “top,” and “bottom” are used to describe the hardware, the meaning of the terms can change as the integrated circuits are rotated or flipped.

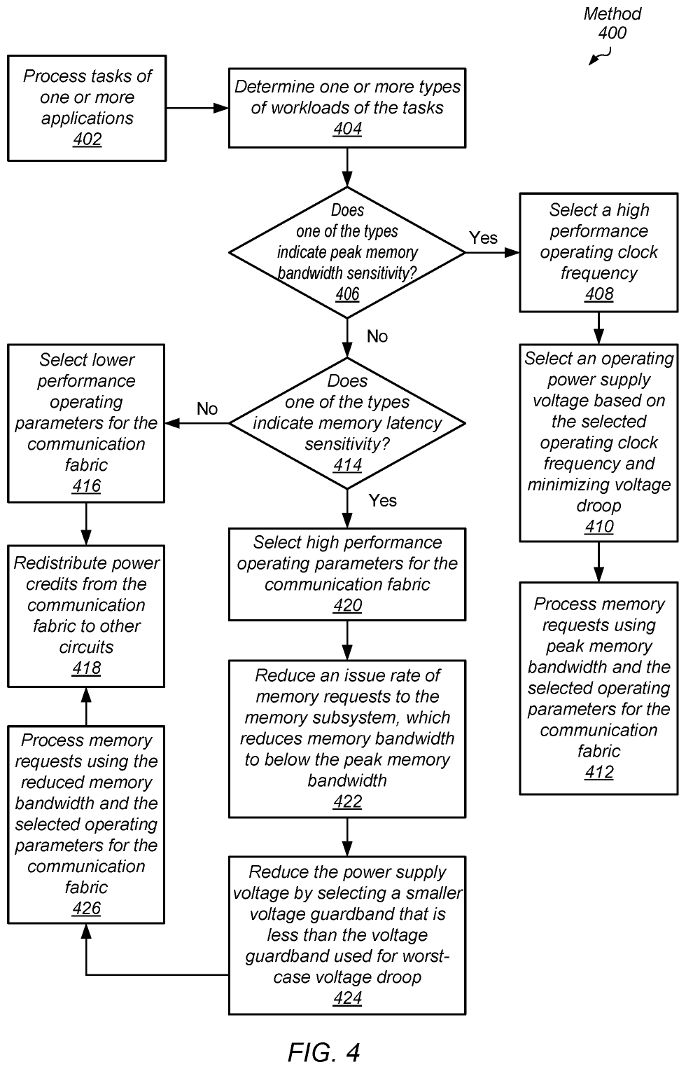

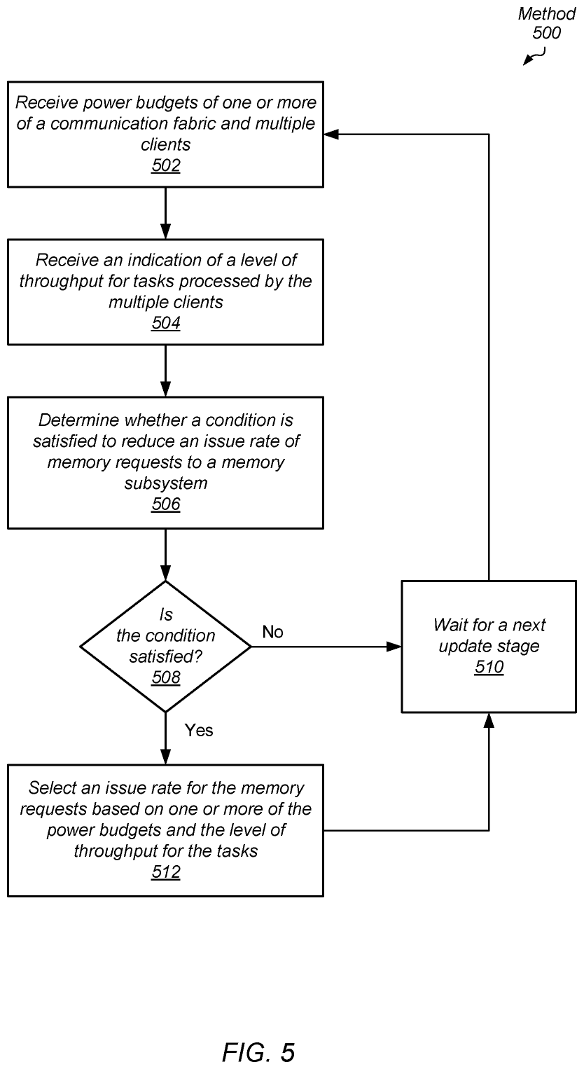

Regarding the methods 400 and 500 (of FIGS. 4 and 5), a computing system includes a memory subsystem and multiple clients that include circuitry for processing tasks. The computing system also includes a communication fabric that transfers data between the memory subsystem and the multiple clients. Referring to FIG. 4, a generalized block diagram is shown of a method 400 for efficiently managing, based on workload types, current transients that cause voltage transients on a power rail of an integrated circuit. For purposes of discussion, the steps in this implementation (as well as FIG. 5) are shown in sequential order. However, in other implementations some steps occur in a different order than shown, some steps are performed concurrently, some steps are combined with other steps, and some steps are absent.

The multiple clients process tasks of one or more applications (block 402). Circuitry of the communication fabric (or fabric) determines one or more types of workloads of the tasks (block 404). In some implementations, the circuitry receives characterization information that includes one or more of an application identifier (ID), a process identifier, a source identifier of clients that generate memory requests, a hint or other identification from software (e.g., compiler, firmware, application) specifying a workload type, values stored in one or more performance counters, and so forth. In an implementation, the circuitry generates an indication specifying one of the types of workloads is not memory bandwidth sensitive based on a rate of memory requests generated by the multiple clients is less than a threshold. The circuitry generates an indication specifying one of the types of workloads is memory bandwidth sensitive based on the rate of memory requests generated by the multiple clients is greater than the threshold.

If one of the types of workloads indicate peak memory bandwidth sensitivity (“yes” branch of the conditional block 406), then the fabric selects a high-performance operating clock frequency (block 408). The fabric selects an operating power supply voltage based on the selected operating clock frequency and minimizing voltage droop (block 410). In an implementation, a power management circuit of the fabric accesses a table or other data structure that stores values of a voltage-frequency curve generated to reduce voltage transients. The power management circuit selects the power supply voltage based on the voltage margin derived from the voltage-frequency curve. A memory controller of the fabric processes memory requests using peak memory bandwidth and the selected operating parameters for the fabric (block 412).

In various implementations, circuitry of the fabric generates an indication specifying one of the workload types is memory latency sensitive based on a rate of compute-intensive operations is greater than a threshold rate. If none of the types of workloads indicate peak memory bandwidth sensitivity (“no” branch of the conditional block 406), and none of the types of workloads indicate memory latency sensitivity (“no” branch of the conditional block 414), then the power management circuit selects lower performance operating parameters for the fabric (block 416). The power management circuit redistributes power credits from the fabric to other circuits (block 418). The other circuits include at least the multiple clients.

If none of the types of workloads indicate peak memory bandwidth sensitivity (“no” branch of the conditional block 406), and at least one of the types of workloads indicate memory latency sensitivity (“yes” branch of the conditional block 414), then the power management circuit selects high-performance operating parameters for the fabric (block 420). The memory controller of the fabric reduces the issue rate of memory requests to the memory subsystem to reduce memory bandwidth to below the peak memory bandwidth (block 422). In an implementation, the memory controller has a peak memory bandwidth of 1 terabyte (TB) of data per second (1 TB/s) with the memory subsystem. The memory controller issues memory requests every other clock cycle to reduce the memory bandwidth to 500 gigabytes per second (500 GB/s). Other reductions are possible and contemplated. When a scheduler or the memory controller of the fabric reduces, delays, or postpones scheduling the next memory requests for issue to the memory subsystem, the fabric throttles the memory request issue rate. Therefore, the fabric balances high throughput and low voltage transients.

The power management circuit reduces the power supply voltage of the operating parameters for the fabric by selecting a smaller voltage guardband that is less than the voltage guardband used for worst-case voltage droop at the high-performance clock frequency (block 424). The memory controller of the fabric processes memory requests using the reduced memory bandwidth (due to the reduced issue rate), the reduced power supply voltage, and the high-performance operating clock frequency for the fabric (block 426). The fabric processes tasks, such as data transfers, that do not produce voltage transients despite using the high-performance operating clock frequency. Afterward, control flow of method 400 moves to block 418 where the power management circuit redistributes power credits from the fabric to other circuits.

Turning now to FIG. 5, a generalized block diagram is shown of a method 500 for efficiently managing, based on workload types, current transients that cause voltage transients on a power rail of an integrated circuit. A power management circuit of the fabric receives power budgets of one or more of the fabric and the multiple clients (block 502). The power management circuit of the fabric receives an indication of a level of throughput for tasks processed by the multiple clients (block 504). The fabric determines whether a condition is satisfied to reduce an issue rate of memory requests to a memory subsystem (block 506). In some implementations, the condition of being satisfied occurs when none of the types of workloads being processed indicate peak memory bandwidth sensitivity, and at least one of the types of workloads indicate memory latency sensitivity.

If the condition is not satisfied (“no” branch of the conditional block 508), then the power management circuit waits for a next update stage (block 510). Afterward, control flow of method 500 returns to block 502 where the power management circuit of the fabric receives power budgets of one or more of the fabric and the multiple clients. If the condition is satisfied (“yes” branch of the conditional block 508), then the memory controller of the fabric selects an issue rate for the memory requests based on one or more of the power budgets and the level of throughput for the tasks (block 512). As described earlier, in an implementation, the memory controller has a peak memory bandwidth of 1 terabyte (TB) of data per second (1 TB/s) with the memory subsystem. The memory controller issues memory requests every other clock cycle to reduce the memory bandwidth to 500 gigabytes per second (500 GB/s). Other reductions are possible and contemplated, and the selected reduction is based on one or more of the power budgets and the level of throughput for the tasks.

In various implementations, the power management circuit reduces the power supply voltage of the operating parameters for the fabric by selecting a smaller voltage guardband that is less than the voltage guardband used for worst-case voltage droop. The memory controller of the fabric processes memory requests using the reduced memory bandwidth (due to the reduced issue rate), the reduced power supply voltage, and a high-performance operating clock frequency for the fabric. The fabric processes tasks, such as data transfers, that do not produce voltage transients despite using the high-performance operating clock frequency. Afterward, control flow of method 500 returns to block 510 where the power management circuit waits for the next update stage.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
an interface configured to receive workload information; and
circuitry, wherein responsive to the workload information indicating a workload is memory latency sensitive, the circuitry is configured to:
cause the apparatus to operate with a first power supply voltage;
reduce an issue rate of memory requests to a memory subsystem; and
cause the apparatus to operate with a second power supply voltage less than the first power supply voltage.

2. The apparatus as recited in claim 1, wherein the circuitry is further configured to redistribute power credits from the apparatus to one or more clients, responsive to the apparatus operating with the second power supply voltage.

3. The apparatus as recited in claim 1, wherein a first voltage guardband of the first power supply voltage is greater than a second voltage guardband of the second power supply voltage.

4. The apparatus as recited in claim 1, wherein the workload information further indicates the workload is not memory bandwidth sensitive.

5. The apparatus as recited in claim 1, wherein the workload information comprises an indication of a compute-intensive application.

6. The apparatus as recited in claim 1, wherein the first power supply voltage corresponds to a high-performance power-performance state.

7. The apparatus as recited in claim 1, wherein the circuitry is further configured to issue memory requests based on the issue rate to a last-level cache of the memory subsystem shared by a plurality of clients.

8. A method, comprising:
receiving, via a communication fabric, workload information; and
responsive to the workload information indicating a workload is memory latency sensitive:
causing the communication fabric to operate with a first power supply voltage;
reducing an issue rate of memory requests to a memory subsystem; and
causing the communication fabric to operate with a second power supply voltage less than the first power supply voltage.

9. The method as recited in claim 8, further comprising redistributing power credits from the communication fabric to a plurality of clients, responsive to the second power supply voltage being assigned to the communication fabric.

10. The method as recited in claim 9, wherein a first voltage guardband of the first power supply voltage is greater than a second voltage guardband of the second power supply voltage.

11. The method as recited in claim 8, wherein the workload information further indicates the workload is not memory bandwidth sensitive.

12. The method as recited in claim 8, wherein the workload information comprises an indication of a compute-intensive application.

13. The method as recited in claim 8, wherein the first power supply voltage corresponds to a high-performance power-performance state.

14. The method as recited in claim 8, further comprising issuing memory requests based on the issue rate to a last-level cache of the memory subsystem shared by a plurality of clients.

15. A computing system comprising:
a plurality of clients, each comprising circuitry configured to process tasks; and
a communication fabric comprising circuitry to:
receive workload information corresponding to tasks executed by circuitry of the plurality of clients;
generate, based on the workload information, an indication that a workload is memory latency sensitive and not memory bandwidth sensitive; and
responsive to the indication:
assign operating parameters of a plurality of operating parameters to the communication fabric comprising a first power supply voltage and an operating clock frequency;
reduce an issue rate of memory requests to a memory subsystem to reduce memory bandwidth below a peak memory bandwidth; and
assign a second power supply voltage less than the first power supply voltage to the communication fabric.

16. The computing system as recited in claim 15, wherein the communication fabric is further configured to redistribute power credits from the communication fabric to the plurality of clients, responsive to the second power supply voltage being assigned to the communication fabric.

17. The computing system as recited in claim 16, wherein a first voltage guardband of the first power supply voltage is greater than a second voltage guardband of the second power supply voltage.

18. The computing system as recited in claim 17, wherein the communication fabric is further configured to generate the indication, responsive to a rate of memory requests generated by the plurality of clients being less than a threshold.

19. The computing system as recited in claim 17, wherein the communication fabric is further configured to generate the indication, responsive to the workload information comprising an indication of a compute-intensive application.

20. The computing system as recited in claim 17, wherein the communication fabric is further configured to assign said operating parameters to the communication fabric, responsive to the first power supply voltage and the operating clock frequency being operating parameters of a high-performance power-performance state (P-state).
